(19) United States
(12) Patent Application Publication
(10) Pub. No.: US 2021/0105293 A1
(43) Pub. Date: Apr. 8, 2021

(54) METHODS AND SYSTEMS FOR ANOMALY DETECTION IN A NETWORKED CONTROL SYSTEM

(71) Applicant: Booz Allen Hamilton Inc., McLean, VA (US)

(72) Inventors: Michael ZARON, Ellicott City, MD (US); Daniel YEAGER, Severna Park, MD (US); Wan WEN, Ellicott City, MD (US); Malcolm MULONG, McLean, VA (US); James PETERSEN, Rockville, MD (US); Laurian VEGA, Columbia, MD (US)

(73) Assignee: Booz Allen Hamilton Inc., McLean, VA (US)

(21) Appl. No.: 16/810,379

(22) Filed: Mar. 5, 2020

Related U.S. Application Data
(60) Provisional application No. 62/911,977, filed on Oct. 7, 2019.

(51) Int. Cl. H04L 29/06; G06N 20/00; G06N 3/08; H04L 29/08

(52) U.S. Cl. CPC H04L 63/1425; G06N 20/00; H04L 67/12; H04L 67/1095; G06N 3/088

(57) ABSTRACT

A system and method for anomaly detection in a networked control system can include: receiving information transmitted over a network at a device; parsing the information at the device to determine whether information specified as relevant to anomaly detection is contained therein, wherein if relevant information is identified, then extracting the relevant information, including, for example protocol information, and saving the relevant information in a first dataset, and if relevant information is not identified, saving the information in a second dataset; storing the first and second datasets on a memory to train a prediction model for anomaly detection; and monitoring network traffic using the prediction model for anomaly detection.

### FIELD

The present disclosure relates to methods and systems for anomaly detection of a networked control system.

### BACKGROUND

Industrial Control Systems in the form of devices, software, and networks providing critical infrastructure such as power, water, gas, manufacturing, and public safety have documented vulnerabilities, such as security compromise and/or operational issues (e.g., operating conditions, malfunctions, normal wear and tear, and so forth). Many of these systems have inadequate, or no integrated, monitoring capabilities. Monitoring capabilities of network operations, such as security issues, are often a lesser priority when creating a system that is functional, safe, and reliable. Although known systems address operational aspects, security is often an afterthought. The full gamut of monitoring issues should not be an afterthought.

Systems often use unique protocols and communication mediums. In an effort to ease the upgrade and integration of devices into these systems, the industry has adapted command and control protocols onto a common medium, known as Industrial Ethernet, using the Internet Protocol (IP) to coordinate communication among devices. A transition onto Industrial Ethernet and IP can simplify the coordinated communication, but in so doing can expose the protocol on added network devices that ultimately pose greater risk of outsider penetration or access. For this reason, an external security monitoring system tailored to networked control systems would be desirable to overcome these added security challenges.

### SUMMARY

A method for anomaly detection for monitoring a networked control system is disclosed. The method can include receiving information (e.g., information contained in data packets, or network traffic of any type or network protocol, and including for example sensor data) transmitted over a network at a device; parsing the information at the device to determine whether information specified as relevant to anomaly detection is contained therein, wherein if relevant information is identified, then extracting the relevant information, including protocol information and saving the relevant information in a first dataset, and if relevant information is not identified, saving the information in a second dataset; storing the first and second datasets on a memory for training a prediction model for anomaly detection; and monitoring network traffic using the prediction model for anomaly detection.

A system for anomaly detection for monitoring a networked control system is also disclosed. The system can include a device configured to receive information transmitted over a network, parse the information to determine information specified as relevant to anomaly detection is contained therein, wherein if relevant information is identified, the device is configured to then extract the relevant information, including protocol information, and save the relevant information in a first dataset, and if relevant information is not identified, the device is configured to save the information in a second dataset; and a memory configured to receive the first and second datasets from the device for training a prediction model for anomaly detection, wherein the prediction model is configured to monitor network traffic in the system for anomaly detection.

### BRIEF DESCRIPTION OF THE DRAWINGS

The scope of the present disclosure is best understood from the following detailed description of exemplary embodiments when read in conjunction with the accompanying drawings, wherein:

FIG. 1 illustrates an exemplary flowchart of a method as disclosed herein for anomaly detection;

FIG. 2 shows an exemplary prototype architecture of an anomaly detection system for an exemplary Industrial Control System (ICS), the anomaly detection system being built on a container orchestration platform in accordance with the present disclosure;

FIG. 3 shows an exemplary visualization of data in a user interface dashboard display according to the present disclosure;

FIG. 4A illustrates an exemplary flowchart of a method for anomaly detection according to the present disclosure;

FIG. 4B illustrates a detailed flowchart for the overall process of FIG. 4A in accordance with an exemplary embodiment; and

FIG. 5 shows an exemplary flowchart for performing parsing according to the present disclosure.

Further areas of applicability of the present disclosure will become apparent from the following detailed description. It should be understood that the detailed description of exemplary embodiments is intended for illustration purposes only and is not intended to limit the scope of the disclosure.

### DETAILED DESCRIPTION

The present disclosure provides an anomaly detection solution for at least one networked control system, which can be at least one or more wired or wirelessly interconnected control systems. The at least one control system can contain an internal or external connection to at least one other device, and the anomaly detection uses prediction algorithms to identify cyber intrusions.

The anomaly detection solution can be applied within the domain of control systems, such as Industrial Control Systems (ICS). Exemplary aspects with respect to ICS networks are provided, however those skilled in the art will appreciate that the anomaly detection solution can be applied to, for example, other similar electronic and/or mechanical systems and to monitoring security as well, e.g., monitoring a network for threat data.

The presently disclosed anomaly detection solution includes techniques to, for example, passively and/or actively collect information such as physical sensor and/or network layer data of a system, and use of data models to analyze data in a context of information specified as “relevant” information. Specified “relevant” information can include a current point in a life cycle of a system, operating conditions of the system (e.g., electrical and/or mechanical operating states, temperature, pressure, vibration, internal and/or external parameters, and so forth), amount of system usage, or any other information transmitted across a network.

The disclosed anomaly detection solution can visualize data and analysis findings with detected anomalies on a user interface (e.g., general user interface). The disclosed solution can be deployed and customized to secure sophisticated ICS environments by early identification of attacks such as scanning, mapping, and targeting.

Advanced network applications and distributed computing can enable the disclosed solution to leverage existing infrastructure of integrated components on a network to reformat (i.e., translate) the device communications into a stream of information (e.g., streaming data) that can be parsed and modeled, and detect abnormal behavior or systematic failures or threats in the associated networks with minimal adverse impact to normal operations. As referenced herein, a minimal adverse impact can be defined as, for example, a lower and/or upper threshold of a user specified, tolerable anomaly to the network and/or system (for example, lower and/or upper latency thresholds in transmitting, receiving and/or processing data such as sensor data in network packets or traffic at one or more network nodes).

In an exemplary embodiment, the network can include at least one device and an analysis engine having analysis components of a first dataset of reference data. The method can include establishing reference data having at least one of known anomalous data that indicates a potential threat, anomalous data that is not perceived to pose a potential threat, and/or non-anomalous data associated with at least one of the devices and the network; and providing instructions for analyzing network data for anomalies.

In an exemplary embodiment, the presently disclosed anomaly detection solution can be an end-to-end framework that is customizable for individual networks and can support on premise and cloud deployment, such as deployment on any distributed network (e.g., a private and/or public cloud-based storage network which uses, for example, at least one or more third-party servers).

Data from physical sensors connected or communicating with the networks can be modeled and presented in real-time using a visualization dashboard that provides information to support end user decision making regarding detected anomalies. For example, network attacks can be detected by examining network traffic volume and timing, and then visualizing potential attack information in a customizable dashboard along with other system data.

Data modeling techniques to predict future values can be based on understanding, baselining, and modeling the individual system at multiple infrastructure layers through, for example, linear regression and comparative modeling (i.e., compare actual data with baselines). This modeling enables the anomaly detection system to detect perturbations from system failures, reconnaissance, or attacks. Modeling in this fashion enables the solutions to incorporate normal situational changes, such as product modifications, evolving attack techniques, etc.

Various aspects of the present disclosure include analyzing passively or actively collected traffic between a system (e.g., ICS) and SCADA (Supervisory Control and Data Acquisition) devices, custom data modeling and correlating among multiple layers and protocols, deploying on air-gapped or connected devices, scaling infrastructure that is scalable, providing streaming data analysis and updated anomaly detection models, and providing user-friendly tiered alert visualizations and dashboards. These aspects are described in full detail with regard to exemplary embodiments disclosed herein.

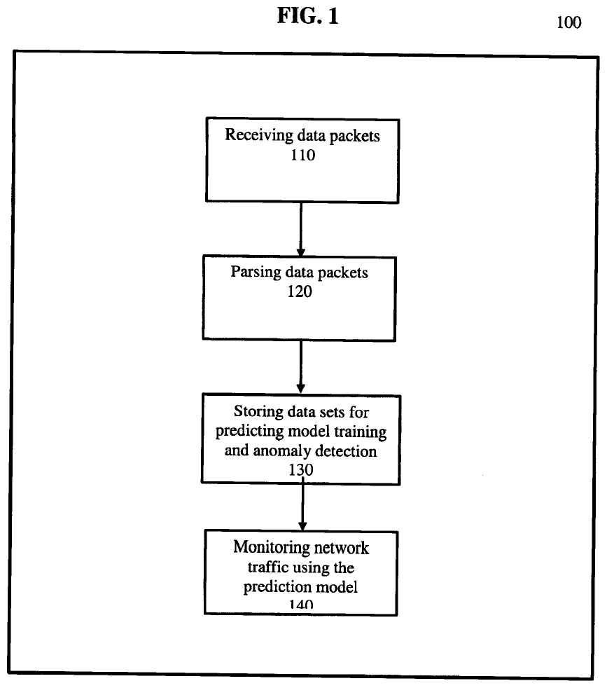

FIG. 1 illustrates an exemplary flowchart of an exemplary method 100 for anomaly detection as disclosed herein. The method 100 includes a step 110 of receiving (e.g., passively and/or actively) information (e.g., data packets or network traffic of any type or protocol and containing information such as sensor data) transmitted over a network at a device. A network, as defined herein, can be at least one or more control systems of a computer network or networks, a data network, such as a digital telecommunications network and so forth, or any combination thereof. An exemplary network can allow virtual and/or actual nodes operating in the network to share resources with each other using connections (data links, wired or wireless) between nodes. These data links can be established in any known fashion, including over cable media, such as wires or optic cables, or wireless media (e.g., WiFi).

The method 100 includes a step 120 of parsing the information (e.g., parsing data packets) at the device to determine whether information relevant to anomaly detection is contained herein. Data packets (e.g., an Internet Protocol (IP) packet), can for example, conform to a protocol of any type and include payload information.

The parsing step 120 can be based off the reformatted (e.g., binary) representation of a data packet and the specification of the protocol that is parsed. The parser can extract network information from, for example, the known MAC, Network, and Transport layers. From there it can, for example, mark the application layer protocol for further extraction later in the process.

The device can be any virtual or any physical network node, which is an active electronic device attached to a network, capable of creating, receiving and/or transmitting information over a communications channel. The device can, for example, be an edge device that is connected to a network terminal access point (TAP) or a mirrored port (e.g., switched port analyzer (SPAN) port available from Cisco Systems, Inc.) in the ICS network to collect data passively. The device can, for example, be connected to a mirrored Ethernet port. In addition, the data can, for example, be collected via an active means such as, for example, an endpoint agent (e.g., a smart sensor having a processor/sensor pair) of a monitored network. This approach can be leveraged on niche networks with single protocols where the traffic doesn't pass through a switch and an endpoint agent would not have user-defined unacceptable adverse effects on the monitored network.

Edge detection processors of an exemplary distributed (e.g., cloud) infrastructure for detecting information can be configured in numerous instantiations. For example, for a given data packet, a first dataset with relevant information can include protocol data and a process value; and a second dataset, when no relevant information is detected, can include only network data. An exemplary pseudo code for such an edge detection instantiation of receiving and parsing data packets, to build data sets for cluster storage is as follows:

## Loop forever
loop {

## Grabs the raw packet
pkt = get_pkt_from_interface( )
## Parses out the Ethernet/TCP/IP layers
parsed = parse_network_protocols(pkt)
## Parses out the ICS Protocol
if parsed.ics_protocol == “MODBUS”
mb = parse_modbus(parsed.packet_data)

process_values[ ]
## Interprets the ICS Protocol
if mb.function_code == READ_REGISTER or WRITE_REGISTER

for i in mb.num_registers

process_values[ i ] = interpret_register(mb.register[ i ] )

else if mb.function_code == READ_COIL or WRITE_COIL

for i in mb.num_coils

process_values[ i ] = interpret_coil(mb.coil[ i ] )

## Builds the dataset with all the network data,
## ICS protocol data, and interpreted process data
json = create_dataset_row(parsed, mb, process_values)

else

## Builds dataset with only the extracted network data
json = create_dataset_row(parsed)

## Send the dataset to the cluster
send_to_cluster(json)

}

The parsing can determine whether the information contains specified “relevant” information that is relevant to anomaly detection. As referenced herein, an “anomaly” can be, without limitation, any deviation from a data model representation of a system's specified acceptable “normal” state or operation on a specific process wherein communications are conducted, using for example, data packets according to a specified communication protocol or protocols having associated parameters such as timing, packet size, and/or latency (e.g., transmission/receipt and/or processing latency).

As referenced herein, specified “relevant” information can include, without limitation, any information content in any format, extracted from network traffic such as a communication packet (e.g., a communication data packet transmitted via a communication protocol), over any period of time, that relates to a system condition (e.g., a state of the system wherein the state or condition can be represented in an analog or digital format, including without limitation, operating conditions, malfunctions, normal wear and tear, and so forth) and/or any system process of interest which is to be monitored against a reference state or threshold.

The information content which is examined can be, for example, register values, parameter values, status of hatches, doors, valves, or gauges, amount of voltage or current across a circuit, internal temperature of a device on the system, environmental temperature of the system, internal or external pressure of the system, vibration, sound, fluid flow, inertia, momentum, angular speed, images of surveilled areas or system components, motion, number of data packets in a specified period of time, and any other measurable attributes or information considered to be “relevant” to anomaly detection either for active system monitoring and/or management, and/or for use in connection with predictive learning as disclosed herein.

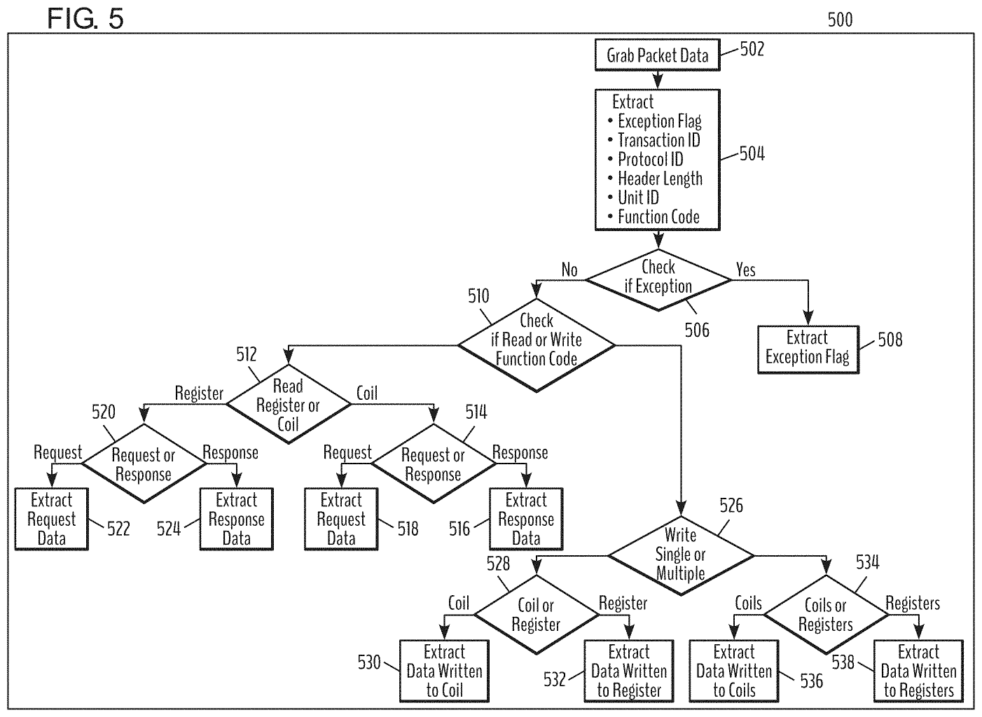

Relevant information extracted from the information for anomaly detection can be saved in a first dataset, and information (i.e., any or all of the information) that is not identified as relevant to an anomaly can be stored in a second dataset. At least one of the first dataset or the second dataset, or both, can be based on, but are not limited to, an exemplary JavaScript object notation (JSON) format. Further details regarding the exemplary parsing will be described with respect to FIG. 5.

Referring to FIG. 1, the method 100 includes a step 130 of storing the first and/or second datasets on a memory (e.g., any memory device of any size and/or form including volatile and/or non-volatile memory) to train a prediction model using artificial intelligence (e.g., machine learning) for future anomaly detection and/or for specifying new forms of “relevant” information. The training of the prediction model during a system architecture training mode can be performed during a monitoring mode using exemplary known techniques, such as unsupervised machine learning as disclosed herein. Exemplary machine learning known techniques are described in Inoue, Y. Yamagata, Y. Chen, C. M. Poskitt and J. Sun, “Anomaly Detection for a Water Treatment System Using Unsupervised Machine Learning,” 2017 IEEE International Conference on Data Mining Workshops (ICDMW), New Orleans, L A, 2017, pp. 1058-1065, the disclosure of which is hereby incorporated by reference in its entirety.

An exemplary implementation of the aforementioned unsupervised machine learning can be a Support Vector Machine (SVM) trained on temperature readings of the monitored system to build an understanding of normal behavior as a baseline against which future communications can be monitored and evaluated. The trained SVM can then monitor a sliding window of new temperature readings and raise an alert when any temperature that is outside normal behavior is detected.

The training of the prediction model via unsupervised machine learning as described is a non-limiting example. Other known models such as Temperature Predicting Model, Component Predicting Model, and Network Predicting Model can also be used.

Temperature Predicting Model—Per this model, there can be two different independent systems running, e.g., a water and heating circulation system and an industrial oven system. The temperature of each system can be reported to a Human Machine Interface (HMI) from a programmable logic controller (PLC) serving as a control system. Using this information, regression and forecasting models can be used to monitor when temperature in either or both systems deviates from a specified normal temperature for each respective system. A change in a system's state may also affect temperature and thus a combination of models for each of the system components can alert a system analyst via a user interface about an inconsistent system state, or change in system state or behavior that is for example, deemed to be abnormal (e.g., outside a given threshold) or inconsistent within a specific or expected norm.

Component Predicting Model—Per this model, a networked control system represented as a programmable logic controller (PLC) reports the state of each component to a human machine interface (HMI). A change in state of one component can trigger a change in the state of the other. There are various permutations of the components' states that can be specified as required state changes for certain actions to occur. For example, once a temperature reaches a certain high level, a flushing pump can be turned on and a radiator activated. This state of events can, for example, be specified as a state condition required for water to be sent to a reservoir to be cooled. In an exemplary embodiment, these states are common and can occur approximately every five minutes (or other time interval) once the system is running.

Known states and time intervals where a change in the system state is expected to occur can be used to help detect anomalies within one or both systems. Such a solution can alert analysts of faulty devices and cyber-attacks. This approach can be used in the foregoing example, to model both the water heating circulation system and the industrial oven systems.

Network Predicting Model—Per this model, the communication between the HMI and PLC is done over the network. Data packets are sent across the network approximately every two to three seconds, or other specified synchronous interval, or asynchronously. HMI and PLC's MAC addresses can be constant and not change unless there is a change in the network environment or devices, such as a potential threat. To capture anomalous behavior that involves or results in higher than normal transmissions of data packets, an average number of data packages sent or received during normal network specified operations over a set time interval can be calculated. This time interval can then be used with, for example, a 3-standard deviations from the mean as a baseline. Any activity that results in network traffic or communication between the PLC and HMI that exceeds a normal specified level can then cause the anomaly detection system to alert the analyst to investigate.

The FIG. 1 method 100 can include a substep within step 130 for determining whether the prediction model is in a training mode or a monitoring mode before training the prediction model, and performing the training when it is determined that the prediction model for the system architecture is in the training mode. The method 100 can, for example, refrain from initiating or continuing training when it is determined that the prediction model is not in a training mode.

The method 100 includes a step 140 of monitoring network traffic using the prediction model for anomaly detection. An anomaly can be detected by establishing a historic behavior of a network based on network characteristics that establish a baseline as already described, and then continuously monitoring the network for events or trends that deviate from the historic behavior or are considered as deviating from a specified norm of the baseline so as to be considered unusual. The comparing of ongoing behavior with historic behavior of the network can include comparing aspects (e.g., parameters of specified aspects of the network regarding ongoing behavior) with historic behavior of individual nodes and/or any combination of nodes of the network for unusual events or trends.

Security can be achieved by monitoring network data traffic in step 140 and extracting as “relevant” information any specific data regarding the system's processes and/or commands that are used to control those processes. In order to reliably collect relevant data traffic, real-time streaming and data manipulation technology, such as data filtering and/or field checksums, can be used to capture appropriate data and commands.

The presently disclosed solutions can use a data pipeline to quickly and easily integrate with existing ICS architectures. Pushing data to a centralized data repository for real-time analysis provides prediction modeling capabilities to detect abnormal sensor fluctuations in or near real-time. This early detection can allow root cause analysis to be performed in an efficient manner, where early proper actions can isolate and limit the impact of the attack on the control process.

These prediction modeling capabilities have been demonstrated on a test platform running two different processes related, for example, to heating and cooling water and air. The platform was created using simulation software where a coefficient of determination represents a specified perfect relationship among data points. Demonstrating this use case involves a practical configuration with some randomness to generate realistic datasets.

A small-scale system, such as an (ICS), can be configured with two PLCs, an HMI, and a network switch to monitor network data traffic among devices. An application for processing and parsing network traffic can passively monitor the data flow and segment the TCP/IP traffic from any protocol, such as for example, a MODBUS protocol or other protocol used by the control system as the disclosed features are protocol agnostic (i.e., any desired protocol being used can be parsed as disclosed herein). This protocol data can then be parsed into functional components providing a structured manner for analysis of sensor data points, commands, requests, responses, and relative features of that specific protocol.

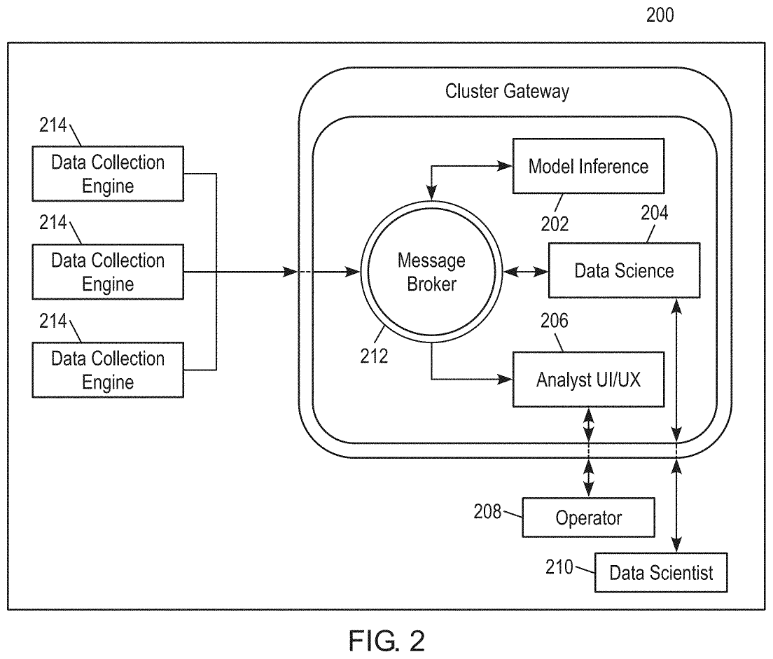

FIG. 2 shows an exemplary prototype of an ICS that is a physical system 200 having container orchestration software cluster that uses a unique data pipeline and processing architecture. The cluster contains three main sections of a model inference module 202, data sequence module 204 for a data scientist user 210, and an analyst UI/UX interface 206 for a system analyst operation 208, all connected through a central message broker 212 as shown in FIG. 2. The three sections as depicted are labeled “Data Science” module 204, “Model Inference” module 202 for storage and active interference, and “Analyst UI/UX” module 206 to allow a user to interact with model-enriched data received via at least one or more data collection engines, or modules, 214.

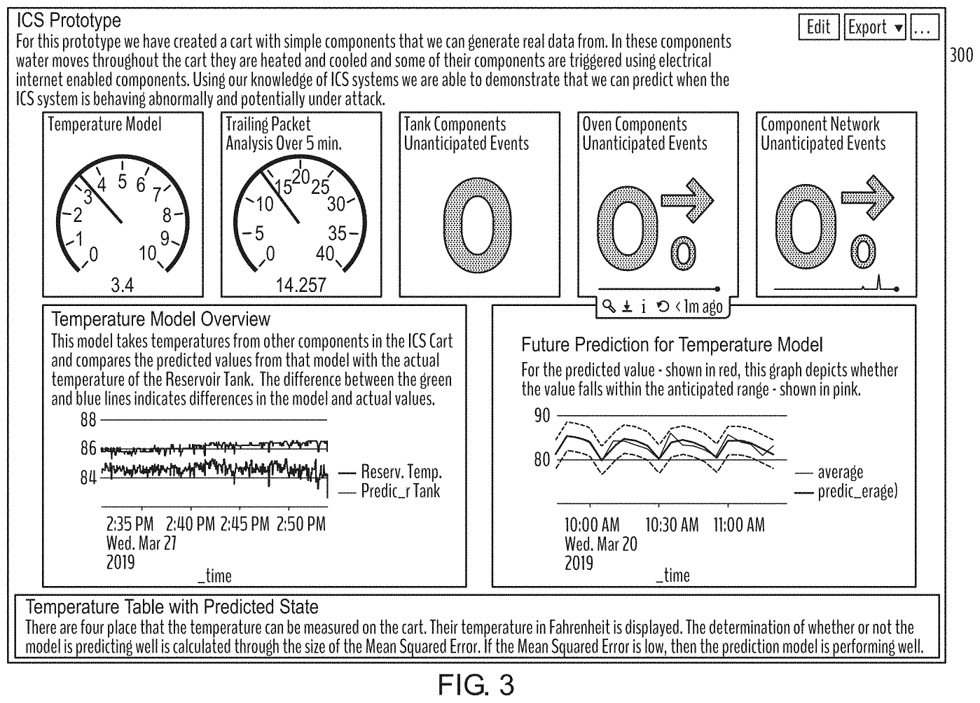

FIG. 3 shows an exemplary ICS prototype embodiment wherein the container orchestration software platform can be the known Kubernetes platform, or another container orchestration software. For this FIG. 3 ICS prototype, an ICS lab, referred to herein for example, as a “cart” has been created with simple components that can generate real data. In these components as water moves throughout the ICS lab of the exemplary prototype disclosed herein, the components are heated and cooled and some of their components are triggered using electrical internet enabled components as in the ICS. It is then possible to predict when the ICS system is behaving abnormally and potentially under attack in accordance with exemplary embodiments as disclosed herein.

An exemplary “temperature model overview” can take temperatures from other components in the ICS lab and compare predicted values from that model with an actual temperature of the Reservoir Tank. A difference between lower and upper lines in the “model overview” graph indicates differences in models vs actual values. For future predictions, a predicted value is shown in the center of the “Future Prediction” graph, and the interface visualizes for the user whether a predicted value falls within an anticipated range between the lowermost and uppermost lines designating an anticipated range.

In an exemplary embodiment, there are four places that the temperature can be measured on the ICS lab. Their temperatures in Fahrenheit are displayed. The determination of whether or not the model is producing well is calculated through a size of a mean squared error. If the mean squared error is low, then the prediction model is performing well.

Referring to FIG. 2, when data flows into the cluster, it first comes into the central message broker 212 which deposits it into a data lake. The data science module offers a familiar environment for an analyst to train and deploy anomaly detection models that are specifically tailored to the system that is in jeopardy. These models are pushed into a storage server and deployed on an enrichment server, where the models are configured to actively parse information and create datasets suitable for analysis by the anomaly detection models, and the datasets are then pushed back to the message broker.

This connection with the central message broker 212 allows multiple models to enrich new data flowing through the pipeline. These enrichments again flow through the central message broker 212 to the analyst section of the cluster where a user interface module 206 is built to display an output of the anomaly detection models so that a user can see and/or determine when there is something wrong (e.g., an anomaly) with the system.

As the system components communicate with one another across the network, data packet headers can be extracted, parsed, and analyzed to determine anomalous behavior. By analyzing data packet headers and changes in the network configuration, communication of unknown devices with a network component can be detected to alert an analyst to investigate.

In the FIG. 3 an exemplary visualization of data in a user interface, the data can be easily understood by ICS personnel. In the top row a user can see the status of how the system is behaving compared to the desired or normal operating values for temperature, traffic volume amounts, and whether an incident of unusual behavior has occurred against the tank, oven, or network component. Once unusual behavior is recognized, the user can see trailing timelines and data tables to further analyze the incident.

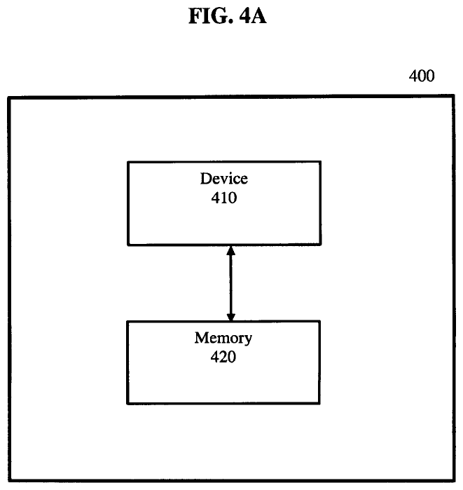

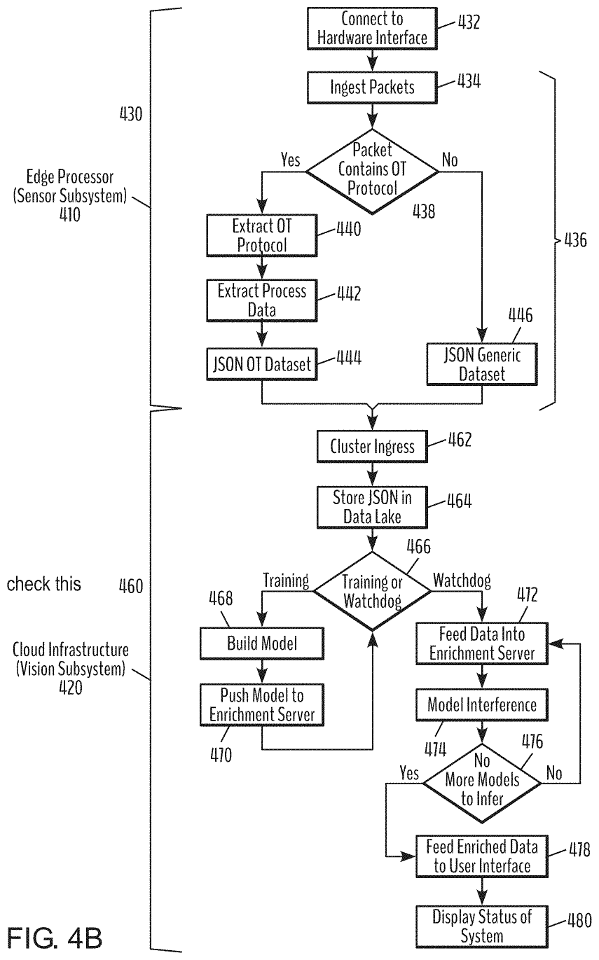

FIG. 4A illustrates an exemplary system 400 for anomaly detection by implementing an embodiment of the present disclosure for performing any of the aforementioned methods. The system 400 can include a device 410 configured to receive information (e.g., data packets transmitted over a network), and parse the information to determine whether information relevant to anomaly detection is contained therein. If relevant information is identified, then the system extracts the relevant information, including protocol information, and saves the relevant information in a first dataset, and if relevant information is not contained therein, the information is saved in a second dataset. A memory 420 can be used to store at least first and second data sets for subsequent display of anomaly detection data on a user interface.

FIG. 4B shows details of the FIG. 4A embodiment. FIG. 4B illustrates the device 410 as an edge processor (sensor subsystem), and the associated memory 420 as a cloud infrastructure 460 (e.g., vision subsystem).

The exemplary edge processor 430 includes a hardware interface connection 432, via which packets are received and ingested at a function block 436 within an injection module (e.g., configured as a software module) 434. The module 436 then processes a packet to determine whether an oblivious transfer (OT) Protocol is included at function block 458. If so, the OT Protocol is extracted at function block 440, processor data is extracted at function block 442 and a JSON (by way of example) OT Dataset (e.g., a first dataset with protocol and process data value information) is created at function block 444. If not, a JSON (by way of example) generic dataset (e.g., a second dataset with only network data) is determined in function block 446.

First and second datasets from function blocks 444 and 446 are then saved via the exemplary cloud ingress connection 462. The datasets are stored at function block 464 in a data lake storage repository, for example, their native format. A module of the cloud infrastructure then performs a training vs watchdog decision at function block 466, based on whether the data set is a first JSON OT dataset or a JSON generic dataset, respectively. If the former, a prediction model is built/updated in function block 468 and the resultant model is, for example, pushed to an enrichment center so that enhanced data can be provided in monitoring of the network based on information inserted in the first and second datasets. If the data is of the second dataset, it is fed via function block 466 to the enrichment server in function block 272, and then to the model inference function block 474. In function block 476, an associated loop is performed to evaluate inferences for all models. Once complete, enriched data is fed to the user interface in function block 478, for display of system status in function block 480.

The process flowchart thus includes transmitting the first and second datasets from the device to a cloud infrastructure to train a prediction model for anomaly detection and for monitoring network traffic using the prediction model to execute anomaly detection. Exemplary aspects of training the prediction model are described herein in detail. The Temperature Predicting Model, Component Predicting Model, and Network Predicting Model as described are merely non-limiting examples. Other similar known models can also be used.

As already described, if information within a data packet is identified as relevant information, the FIG. 4 device 410 extracts the relevant information, including protocol information, from the data packet and saves the relevant information in a first dataset, and relevant information is not identified, the device 410 saves the information (i.e., the data packet, or subset) thereof in a second dataset.

The FIG. 4 system 400 uses memory 420 to receive the first and second datasets from the device for training a prediction model for anomaly detection, wherein the prediction model is configured to monitor network traffic in the system for anomaly detection.

FIG. 5 shows an exemplary flowchart for performing the parsing step 120 using the MODBUS protocol, although any specified protocol can be used.

Referring to FIG. 5, the flowchart includes exemplary functions that begin with an initial function to grab packet data 502 associated with an ICS which can be extracted and saved with a first or second dataset as desired. An extracting of information occurs in function block 504. For example, a decision can be performed in function lock 506 to check if an exception flag has been set within the data packet received. Other information extracted from the data packet in function block 504, in addition to an exception flag, can include, without limitation a transaction ID, a protocol ID, header length data, unit ID, and function code.

In function block 506, if an exception flag has been detected, it is extracted in function block 508. Otherwise, process flow proceeds to function block 510 to check whether a read or write function code is included in the data packet information.

If a read function code is present in function block 510 (e.g., read a register or coil for the exemplary system disclosed herein) a decision is made between types of read functions (e.g., register or coil) in decision function block 512. If in this example, a coil function code is detected, process flows to decision function block 514 to distinguish a request vs a response, and in dependence thereon, response data is extracted in function block 516 or request data is extracted in function block 518.

For a register function code detected in decision function block 512, process flows to function blocks 520, 522, and 524 to similarly extract request or response data.

Returning to decision function block 510, if a write function code is detected as present, a process flows to decision function block 526 to distinguish single vs multiple write functionality. Where a single write function is designated, process flows to function blocks 528, 530 and 532 to extract data written to a coil or to a register, respectively. Similar process function blocks 534, 536 and 538 extract data written to multiple coils or registers, respectively. Any or all such information can be included in the first and/or second dataset to enhance a user's understanding of the context in which ICS anomalies are being detected (e.g., single read vs multi-write operations).

Those skilled in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, one or more of the disclosed modules can be a hardware processor device with an associated memory.

Various embodiments of the present disclosure are described in terms of an exemplary computing device acting within or within a computer network or networks. Based on this description, it will be apparent to those skilled in the art how to implement the present disclosure using any computer system and/or computer architecture.

Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

A system, as used herein, can be in combination with one or more physical and/or virtual nodes, wherein the system resides in the one or more nodes. A node can be configured to interface or contain one or more components of the systems described herein.

A hardware processor device, as used herein, can be any special purpose or a general purpose processor device or devices. The hardware processor device can be connected to a communications infrastructure, such as a bus, message queue, network, multi-core message-passing scheme, etc. An exemplary computing device, as used herein, can also include a memory (e.g., random access memory, read-only memory, etc.), and can also include one or more additional memories. The memory and the one or more additional memories can be read from and/or written to in a well-known manner. In an embodiment, the memory and the one or more additional memories can be non-transitory computer readable recording media.

Data stored in the exemplary computing device (e.g., in a memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc.

Memory semiconductors (e.g., DRAMs, etc.) can serve as means for providing software to the computing device. Computer programs (e.g., computer control logic) can be stored in the memory. Computer programs can also be received via the communications interface. Such computer programs, when executed, can enable the computing device to implement the present methods as discussed herein. Computer programs stored on a non-transitory, computer-readable medium, when executed, can enable a hardware processor device to implement the exemplary methods, or similar methods, as discussed herein. Accordingly, such computer programs can represent controllers of the computing device.

Where the present disclosure is implemented using software, the software can be stored in a computer program product or non-transitory, computer-readable medium and loaded into the computing device using a removable storage drive or communications interface. In an exemplary embodiment, any computing device disclosed herein can also include a display interface that outputs display signals to a display unit, e.g., LCD screen, plasma screen, LED screen, DLP screen, CRT screen, etc.

The following documents demonstrate aspects regarding the level of skill in the art, and are incorporated by reference herein in their entireties:
1) M. Kravchik and A. Shabtai, “Detecting Cyber Attacks in Industrial Control Systems using Convolutional Neural Networks,” in ACM Proceedings of the 2018 Workshop on Cyber-Physical Systems Security and Privacy (CPS-SPC '18), pp. 72-83, 2018.
2) Q. Lin, S. Adepu, S. Verwer, and A Mathur, “TABOR: A Graphical Model-based Approach for Anomaly Detection in Industrial Control Systems,” in ACM Proceedings of the 2018 on Asia Conference on Computer and Communications Security, pp 525-536, June 2018.
3) R. C. Borges Hink, J. M. Beaver, M. A. Buckner, T. Morris, U. Adhikari and S. Pan, “Machine learning for power system disturbance and cyber-attack discrimination,” 2014 7th International Symposium on Resilient Control Systems (ISRCS), Denver, Colo., 2014, pp. 1-8.
4) Robles-Durazno, N. Moradpoor, J. McWhinnie and G. Russell, “A supervised energy monitoring-based machine learning approach for anomaly detection in a clean water supply system,” 2018 International Conference on Cyber Security and Protection of Digital Services (Cyber Security), Glasgow, 2018, pp. 1-8.
5) S. Han, M. Xie, H. Chen and Y. Ling, “Intrusion Detection in Cyber-Physical Systems: Techniques and Challenges,” in IEEE Systems Journal, vol. 8, no. 4, pp. 1052-1062, December 2014.
6) J. Inoue, Y. Yamagata, Y. Chen, C. M. Poskitt and J. Sun, “Anomaly Detection for a Water Treatment System Using Unsupervised Machine Learning,” 2017 IEEE International Conference on Data Mining Workshops (ICDMW), New Orleans, L A, 2017, pp. 1058-1065.
J. Decotignie, “The Many Faces of Industrial Ethernet [Past and Present],” in IEEE Industrial Electronics Magazine, vol. 3, no. 1, pp. 8-19, March 2009.doi: 10.1109/MIE.2009.932171.

It will be appreciated by those skilled in the art that the present disclosure can be embodied in other specific forms without departing from the spirit or essential characteristics thereof. The presently disclosed embodiments are therefore considered in all respects to be illustrative and not restrictive. The scope of the disclosure is indicated by the appended claims rather than the foregoing description, and all changes that come within the meaning, range, and equivalence thereof are intended to be embraced therein.

1. A method for anomaly detection in a networked control system, the method comprising:
receiving information transmitted over a network at a device;
parsing the information at the device to identify relevant information and non-relevant information to anomaly detection contained therein;
extracting the relevant information, the relevant information including protocol information;
saving the relevant information in a first dataset;
saving the non-relevant information in a second dataset;
storing the first and second datasets on a memory for training a prediction model for anomaly detection; and
monitoring network traffic using the prediction model for anomaly detection.

2. The method of claim 1, comprising:
determining whether the prediction model is in a training mode or a monitoring mode before training the prediction model, and performing the training when it is determined that the prediction model is in a training mode.

3. The method of claim 1, comprising:
performing training during a monitoring mode using unsupervised machine learning.

4. The method of claim 1, wherein the information is network data packets received at the device from a network terminal access point (TAP).

5. The method of claim 1, wherein the information is network data packets received at the device from a mirrored port.

6. The method of claim 1, wherein the first dataset and/or the second dataset is based on a javascript object notation (json) format.

7. The method of claim 1, comprising:
displaying a status of the anomaly detection.

8. The method of claim 1 for anomaly detection in an industrial control system (ICS).

9. The method of claim 1, wherein the device is an edge device.

10. The method of claim 1, wherein the network includes at least one device and an analysis engine having analysis components of a first dataset of reference data, the method comprising:
establishing reference data having at least one of known anomalous data that indicates a potential threat or anomalous data that is not perceived to pose a potential threat or non-anomalous data associated with at least one of the at least one device and the network and instructions for analyzing network data for anomalies.

11. The method of claim 10, wherein at least one component of the analysis engine is located on a distributed network.

12. The method of 10, wherein the analysis engine is trained to identify data as being indicative of anomalies that pose a threat and other data as being indicative of a perceived lack of threat.

13. The method of claim 10, wherein the analysis engine is trained using data from the at least first and/or second datasets.

14. The method of claim 1, wherein the receiving includes at least one of: passively or actively collecting information of a network.

15. A system of anomaly detection for a networked control system, the system comprising:
a device configured to receive information transmitted over a network, and to parse the information to determine whether information relevant to anomaly detection is contained therein, wherein if relevant information is identified, the device then extracts the relevant information, including protocol information, and saves the relevant information in a first dataset, and if relevant information is not contained therein, the device saves the information in a second dataset; and
a memory configured to receive the first and second datasets from the device for training a prediction model for anomaly detection, wherein the prediction model is configured to monitor network traffic in the system for anomaly detection.

16. The system of claim 15, comprising:
a network terminal access point (TAP) configured to transmit the information as network data packets to the device.

17. The system of claim 15, comprising:
a mirrored port configured to transmit the information as network data packets to the device.

18. The system of claim 15, wherein the first dataset and/or the second dataset is based on a javascript object notation (json) format.

19. The system of claim 15, comprising:
a display that displays a status of the anomaly detection.

20. The system of claim 15, wherein the network control system is an industrial control system.

21. The system of claim 15, wherein the networked control system is a distributed control system.

22. The system of claim 15, wherein the system device is an edge device configured to at least one of actively or passively collecting data.

23. The system of claim 15 wherein the memory device is a cloud infrastructure.
